(19) United States
(12) Patent Application Publication
(10) Pub. No.: US 2006/0103730 A1
(43) Pub. Date: May 18, 2006

(54) Wireless camera with cdma module and motion picture transmission system using the same

(76) Inventor: Yun-Kyung Jung, Seoul (KR)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(21) Appl. No.: 10/549,096

(22) PCT Filed: Feb. 11, 2004
(86) PCT No.: PCT/KR04/00267

§ 371 Date: Sep. 13, 2005

(30) Foreign Application Priority Data
Feb. 11, 2003 (KR) 10-2003-0008468

(51) Int. Cl. H04N 5/225

(52) U.S. Cl. 348/207.99

(57) ABSTRACT

The present invention relates to a wireless camera with a code division multiple access (CDMA) module and a motion picture transmission system using the wireless camera, and more particularly, a motion picture processor, a communication processor comprising a ringing detector and the CDMA module; a control part comprising a microprocessor and a memory storing a system operation program; and a power controller comprising a battery for supply operation power and a power switch controlled by the microprocessor to switch power supply.

### TECHNICAL FIELD

The present invention relates to a wireless camera with a code division multiple access (CDMA) module and a motion picture transmission system using the wireless camera, and more particularly, to a wireless camera with a CDMA module and a motion picture transmission system using the wireless camera that allow a user to identify a situation of a remote location in real time by directly calling the wireless camera using a mobile terminal.

### BACKGROUND ART

Generally, a closed-circuit television (CCTV) is an image storage system that is installed on a location where an administration of incoming/outgoing persons is required to prevent an incident in advance. The image data stored in the image storage system can be also used as corroborative facts for an incident. That is, the CCTV records an image signal captured and plays back the recorded image signal. Therefore, the CCTV is widely used in, for example, banks, and the like.

Such a conventional CCTV requires a separated repeater for performing a remote communication control as well as a large capacity of storage, increasing a manufacturing costs and volume thereof. The increased volume of the CCTV makes it difficult to install the CCTV due to a limited space.

Meanwhile, as a mobile communication system using CDMA technology has been widely applied in accordance with IS-95 standard, mobile communication companies have proposed a variety of services using the mobile communication system meet the subscribers' wants. That is, a variety of services that are realized by associating the mobile communication system with a variety of other systems have been provided to the subscribers.

The present invention is directed to one of the services using the mobile communication system.

### DISCLOSURE

Accordingly, the present invention is directed to a wireless camera with a code division multiple access (CDMA) module and a motion picture transmission system that substantially obviates one or more problems due to limitations and disadvantages of the related art.

It is an objective of the present invention to provide a wireless camera with a CDMA module and a motion picture transmission system using the wireless camera that allow a user to identify a situation of a remote location in real time by directly calling the wireless camera using a mobile terminal or vice versa.

To achieve the object, the present invention provides a wireless camera with a CDMA module, comprising a motion picture processor for taking an image; a communication processor comprising a ringing detector for generating a ringing signal by detecting a calling-connection signal to the CDMA module that processes a communication signal for a wireless transmission of the image; a control part comprising a microprocessor for operating a whole system by detecting the ringing signal and controlling image and sound signals and a memory storing an identification code of a mobile communication terminal and a system operation program including an image processing program; and a power controller comprising a battery for supplying operation power and a power switch controlled by the microprocessor to switch power supply.

The motion picture processor may comprise a shutter operated by the microprocessor, an image capturer for capturing an image using a charge coupled device, a sound capturer for capturing a sound, an image signal processor for receiving an image signal from the image capturer, extracting correlated double sampling (CDS) data from the image signal, and performing an auto gain controller (AGC) amplification, an A/D converter for converting data of the image signal processor into R, G and B image data through a digital formatting, an image data compressor for compressing the R, G and B image data, a buffer memory 16 for temporarily storing the compressed image data, an address oscillator for supplying a writing address (Wad) used for writing to the buffer memory, and an image transmitter for generating a signal to be transmitted from the mobile communication terminal to the communication processor.

The CDMA module may comprise first and second channel encoders for respectively coding a transmission signal into first and second predetermined coding rates; first and second interleavers for interleaving corresponding coding data by a frame; a selector for connecting the transmission signal to the corresponding channel encoder having the corresponding coding rate using a coding rate selecting signal and selecting and outputting output of the corresponding interleaver; a quadrature modulator for generating a quadrature code corresponding quadrature code information and spreading the coding data outputted from the selected interleaver as the quadrature code; and a PN spreader for spreading and transmitting the quadrature code.

The wireless camera may further comprise an object-detecting sensor coupled to the microprocessor.

Preferably, the object-detecting sensor is an infrared sensor or a microwave sensor module.

The microwave sensor module comprises a radio frequency oscillator for generating radio frequency; a radio frequency amplifier for amplifying the radio frequency; a transmitting antenna for transmitting the amplified radio frequency to the air; a receiving antenna for receiving the radio frequency sent from the transmitting antenna, the receiving antenna being integrated with the sensor circuit part; a frequency synthesizing part for synthesizing the signal reflected from an object and the radio frequency; and a frequency converting part for converting the synthesized frequency into frequency of a medium frequency band.

The quadrature code information includes a quadrature code number and a quadrature code length.

The motion picture processor comprises a charge couple device.

According to another aspect of the present invention, there is provided a motion picture transmission system using a wireless camera with a CDMA module, comprising a motion picture processor comprises a shutter operated by a microprocessor, an image capturer for capturing an image using a charge coupled device, a sound capturer for capturing a sound, an image signal processor for receiving an image signal from the image capturer, extracting correlated double sampling (CDS) data from the image signal, and performing an auto gain controller (AGC) amplification, an AID converter for converting data of the image signal processor into R, G and B image data through a digital formatting, an image data compressor for compressing the R, G and B image data, a buffer memory for temporarily storing the compressed image data, an address oscillator for supplying a writing address (Wad) used for writing to the buffer memory, and an image transmitter for generating a signal to be transmitted from the mobile communication terminal to the communication processor; a communication processor comprising the CDMA module including first and second channel encoders for respectively coding a transmission signal into first and second predetermined coding rates, first and second interleavers for interleaving corresponding coding data by a frame, a selector for connecting the transmission signal to the corresponding channel encoder having the corresponding coding rate using a coding rate selecting signal and selecting and outputting output of the corresponding interleaver, a quadrature modulator for generating a quadrature code corresponding quadrature code information and spreading the coding data outputted from the selected interleaver as the quadrature code, and a PN spreader for spreading and transmitting the quadrature code and a ringing detector for generating a ringing signal by detecting a calling-connecting signal to the CDMA module; a control part comprising the microprocessor for operating a whole system by detecting the ringing signal and controlling image and sound signals and a memory storing an identification code of a mobile communication terminal and a system operation program including an image processing program; a power controller comprising a battery for supplying operation power and a power switch controlled by the microprocessor to switch power supply; and a mobile communication terminal for receiving the motion picture information by call-connecting the wireless camera.

It is to be understood that both the foregoing general description and the following detailed description of the present invention are exemplary and explanatory and are intended to provide further explanation of the invention as claimed.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a control circuit of a wireless camera with a CDMA module and a motion picture transmission system using the wireless camera according to a first embodiment of the present invention;

FIG. 2 is a block diagram illustrating a control circuit of a wireless camera with a CDMA module and a motion picture transmission system according to a second embodiment of the present invention;

FIG. 3 is a block diagram of a CDMA used for a wireless camera according to an embodiment of the present invention;

FIG. 4 is a flowchart illustrating a motion picture transmission process when a mobile communication terminal calls a wireless camera having a CDMA module according to a preferred embodiment of the present invention; and

FIG. 5 is a flowchart illustrating a motion picture transmission process when a wireless camera with a CDMA module calls a mobile communication terminal according to a preferred embodiment of the present invention.

### BEST MODE

Reference will now be made in detail to the preferred embodiments of the present invention, examples of which are illustrated in the accompanying drawings. Wherever possible, the same reference numbers will be used throughout the drawings to refer to the same or like parts.

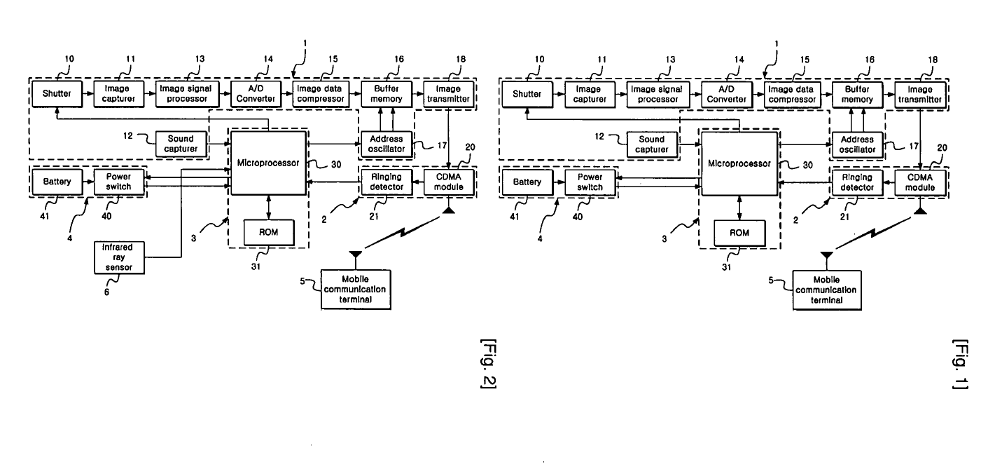

FIG. 1 shows a block diagram illustrating a control circuit of a wireless camera with a CDMA module and a motion picture transmission system using the wireless camera according to a first embodiment of the present invention.

As shown in the drawing, a wireless camera with a CDMA module comprises a motion picture processor 1, a communication processor 2, a central process unit 3, and a power controller 4.

The motion picture processor 1 comprises a shutter 10 operated by a microprocessor 30 that will be described later, an image capturer 11 for capturing an image using a charge coupled device (CCD) having, for example, red (R), green (G) and blue (B) pixels, a sound capturer 12 for capturing a sound using a microphone, an image signal processor 13 for receiving an image signal from the image capturer 11, extracting correlated double sampling (CDS) data from the image signal, and performing an auto gain controller (AGC) amplification, an A/D converter 14 for converting data of the image signal processor 13 into R, G and B image data through a digital formatting, an image data compressor 15 for compressing the R, G and B image data, a buffer memory 16 for temporarily storing the compressed image data, an address oscillator 17 for supplying a writing address (Wad) used for writing to the buffer memory 16, and an image transmitter 18 for generating a signal to be transmitted to the CDMA module 20.

The operation of the motion picture processor 1 will be briefly described hereinafter.

When the shutter 10 is opened by the control of the microprocessor 30, light reflected from a subject is transmitted to the CCD through a lens to define an image of the subject and is outputted as an electric signal in response to an amount of the light transmitted. That is, R, G and B signals are outputted as an image signal. Then, the image signal processor 13 performs the CDS data extraction and the AGC amplification, and the A/D converter 14 converts the analog image data into the digital image data. The digital data are compressed by the image data compressor 15 to be suitable for the communication. That is, the data is compressed in a format identical to the CDMA module 20 formed considering a writing capacity, a frequency band, and other parameters.

When the image data is outputted from the image data compressor 15, the buffer memory 16 stores the data received in accordance with the supplied writing address (Wad). Here, the address oscillator 17 is comprised of a writing address counter, a reading address counter and a clock generator.

The count values of the writing and reading address counters are used to generate writing and reading addresses. The writing and reading operations via the buffer memory 16 is realized by generating the writing and reading addresses (Wad and Rad). Such addresses are generated in response to the writing request from the microprocessor 30 or the image data compressor 15.

For example, the image data compressor 15 periodically outputs the writing request in response to the output of the image data. The writing address counter of the address oscillator 17 consecutively outputs the writing address (Wad) by counting. This allows the image data obtained through the image pickup operation to be consecutively placed on the buffer memory 16.

The writing address counter performs the counter based on a standard clock signal generated by the clock generator. The clock signal is maintained to synchronize with the clock signal of the CCD transmission operation by the image capturer 11. Meanwhile, the image data placed on the buffer memory 16 is recovered in accordance with the writing address. The recovered image data is transmitted to the CDMA module 20.

Meanwhile, the sound capturer 12 decodes sound data received in accordance with a sound signal transmission method selected. That is, the sound capturer 12 demodulates the sound signal and performs the A/D converting operation. The digital sound data are matched with the image by the microprocessor 30 and are then transmitted to the image transmitter 18. The image transmitter 18 decodes the sound d ata together with the image data transmitted from the buffer memory 16 according to an effective writing format. The decoded data are transmitted to the CDMA module 20.

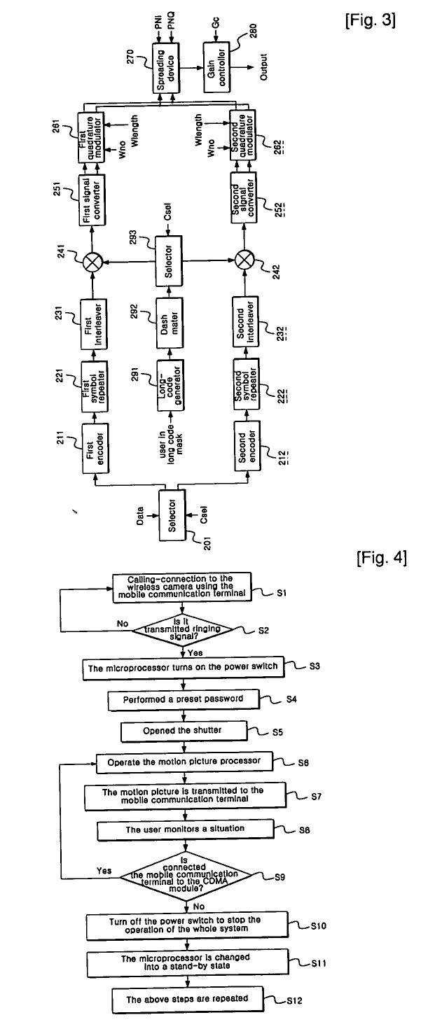

The communication processor 2 is comprised of the CDMA module 20 for transmitting signal and a ringing detector 21 for detecting a ringing signal generated in response to a call from a mobile communication terminal 5. The ringing detector 21 is preferably formed of a hole sensor or a differential current sensor that can detect current using a coil. The CDMA module will be described with reference to FIG. 3.

The central process unit 3 is comprised of the microprocessor 30 for performing the power control by receiving the ringing signal inputted from the communication processor 2 and for transmitting the image processing control signal to the motion picture processor 1 and a ROM 31 for storing an operating program as well as an image compressing program and an communication program. The ROM 31 can further store a generic code of the mobile communication terminal 5 for the calling-connection.

The power controller 4 is comprised of a power switch 40 controlled by the microprocessor 300 to control the power supply and a battery 41 for supplying power to the whole system. At this point, the on/off control of the power switch 40 by the microprocessor 300 is realized by supplying a hot stand-by power to the microprocessor 300. That is, even when the power supplied to the whole system is cut-off, a threshold power is supplied to detect the ringing signal inputted from the communication processor 2.

Here, in order to complete the constitution of the wireless camera and the image information transmission system, the CDMA module 20 and the mobile communication terminal 5 are provided.

FIG. 1 shows a block diagram illustrating a control circuit of a wireless camera with a CDMA module and a motion picture transmission system using the wireless camera according to a second embodiment of the present invention.

This second embodiment differs from the first embodiment in that a sensor for detecting an object is coupled to the microprocessor 30. Therefore, the sensing signal generated by the object-detecting sensor is processed by the microprocessor 30 to function to generate a calling signal of the mobile communication terminal 5 as well as an image processing control signal. The object-detecting sensor is preferably formed of an infrared ray sensor 6. The infrared ray sensor 6 is designed to detect a predetermined space. When there are lots of obstacles, it is preferable that a sensor module using microwave is used as the object-detecting sensor. The sensor module using microwave is generally comprised of a radio frequency oscillator for generating radio frequency, a radio frequency amplifier for amplifying the radio frequency, a transmitting antenna for transmitting the amplified radio frequency to the air, a receiving antenna for receiving the radio frequency sent from the transmitting antenna, the receiving antenna being integrated with the sensor circuit part, a frequency synthesizing part for synthesizing the signal reflected from an object and the radio frequency, and a frequency converting part for converting the synthesized frequency into frequency of a medium frequency band.

FIG. 3 shows a block diagram of a CDMA used for a wireless camera according to an embodiment of the present invention;

As shown in the drawing, the CDMA module of the present invention is formed of a forwarding link traffic channel-sensing device having a ⅓ rate encoder and a ⅙ rate encoder.

A selector 201 has a first output end coupled to a first encoder 211 and a second output end coupled to a second encoder 211. The selector 201 inputs transmitting data and selectively outputs input data one of the first and second encoders 211 and 212 in response to a selection signal (Csel) outputted from a control part (not shown).

The data input of the first encoder 211 depends on the output of the selector 201. The first encoder 211 encodes and punctuates the data inputted when the input data are generated in the selector 201 as a ⅓ coding rate and outputs the same as a symbol. That is, the first encoder 211 encodes each one-bit of the input data into three symbols. As the first encoder 211, a weaving encoder or a turbo-encoder can be used. A first symbol repeater 221 inputs data encoded as the first coding rate and repeatedly outputs symbols such that the symbols encoded and inputted as different bit rates can have an identical symbol rate. A first interleaver 231 is deigned to interleave the first encoded data outputted from the fist symbol repeater 221 and outputs the same. The first interleaver 231 can be formed of a block interleaver.

The data input of the second encoder 212 depends on the output of the selector 201. The second encoder 212 encodes and punctuates the data inputted when the input data are generated in the selector 201 as a ⅙ coding rate and outputs the same as a symbol. That is, the second encoder 212 encodes each one-bit of the input data into six symbols. As the second encoder 212, a weaving encoder or a turbo-encoder can be used. A second symbol repeater 222 inputs data encoded as the second coding rate and repeatedly outputs symbols such that the symbols encoded and inputted as different bit rates can have an identical symbol rate. A second interleaver 232 is deigned to interleave the first encoded data outputted from the fist symbol repeater 222 and outputs the same. The first interleaver 232 can be formed of a block interleaver.

A long-code generator 291 generates a long-code that is an identification code of each subscriber. A dash mater 292 performs a dash-mate of the long-code such that the long-code can be identical to the symbol rates outputted from the first and second interleavers 231 and 232. The selector 293 inputs the output of the dash mater 292 and selectively outputs the dash-mated long-code by an encoder selection signal (Csel) to one of first and second mixers 241 and 242. That is, the selector 293 outputs the dash-mated long-code to the first mixer 241 when the ⅓ coding rate is selected. The selector 293 outputs the [symbol] [symbol] long-code to the second mixer 242 when the ⅙ coding rate is selected. The first mixer 241 mixes the first encoded data outputted from the first interleaver 231 with the long-code outputted from the selector 293 and outputs the same. The second mixer 242 mixes the second encoded data outputted from the second interleaver 232 with the long-code outputted from the selector 293 and outputs the same.

A first signal converter 251 converts a level of binary data outputted from the first mixer 241 and outputs the same. That is, the first signal converter 251 converts data ‘0’ into +1 and converts data ‘1’ into −1. A first quadrature modulator 261 includes a first quadrature code generator that generates a first quadrature code for quadrature-modulating the first encoded data using a quadrature code number and a quadrature length. That is, the first quadrature modulator 261 generates the first quadrature code according to the quadrature code number and the quadrature code length and multiplies the same with the data outputted from the first signal converter 251 to generate a first quadrature-modulating signal. Here, it is assumed that a Walsh code is used as the quadrature code and a Walsh code having a 256-code length is used for the first coding rate (⅓ coding rate).

A second signal converter 252 converts a level of binary data outputted from the second mixer 242 and outputs the same. That is, the second signal converter 252 converts data ‘0’ into +1 and converts data ‘1’ into −1. A second quadrature modulator 262 includes a second quadrature code generator that generates a second quadrature code for quadrature-modulating the first encoded data using a quadrature code number and a quadrature length. That is, the second quadrature modulator 262 generates the second quadrature code according to the quadrature code number and the quadrature code length and multiplies the same with the data outputted from the second signal converter 252 to generate a second quadrature-modulating signal. Here, it is assumed that a Walsh code is used as the quadrature code and a Walsh code having a 128-code length is used for the second coding rate (⅙ coding rate).

A spreading device 270 receives one of the first and second quadrature modulating signals outputted from the first and second quadrature modulators 261 and 262, mixes the received signal with a spreading sequence, and spreads and outputs the mixed transmitting signal. A PN-sequence can be used as the spreading sequence. A QPSK spreading device can be used as the spreading device 270. A gain controller 280 inputs the output of the spreading device 270 and controls the gain of the spreading signal inputted using a gain control signal (Gc).

The operation of the CDMA module 20 will be briefly described hereinafter.

The control part (not shown) analyzes parameters outputted from the receiving device (not shown) and determines if a code rate is converted. The parameters include signal intensities (RSSI, Ec/Io, Eb/Io and the like), an accumulated value of a received PCB for a predetermined period, and a message INFO requesting the converting of the coding rate. The transmitter first checks out if the signal intensity received during the communication is less than a preset minimum critical value. When the signal intensity is less than the minimum critical value, the control part may generate a control signal for lowering the current coding rate. The receiving signal intensity means that it includes the RSSI, Ec/Io, Eb/Io and the like.

In addition, The CDMA module 20 checks out a signal transmitted from a base station and outputs a power control bit PCB for enhancing or lowering the transmitting power of the base state through a reverse link. Accordingly, the base station checks out the power control bit PCB of the CDMA module 20 and counts the number of power up PCB requesting the enhancement of the power for a predetermined period and the number of power down PCB requesting the lowering the power. The counted value is higher than a predetermined value, the control part may generate a control signal requesting the lowering the current coding rate. On the contrary, the number of power down PCB generates a signal for enhancing the current coding rate.

The request for the converting the coding rate may be done by the CDMA module 20. In this case, the CDMA module 20 requests this using a message INFO. A control part (not shown) of the base station receives the request of the CDMA module 20 through a receiving device (not shown).

The control part may uses parameters different from the above-described parameters. In the present invention, it is consumed that 3 parameters are used. In addition, the control part can be designed such that each of the parameters can be changed with regard to its coding rate. Alternatively, the coding rate may be changed only when a subset of all of the parameters is received. The control part can be further designed such that the coding rate can be lowered when the communication environment is deteriorated, thereby improving the communication condition and such that the coding rate can be enhanced when he communication environment is improved to restore the coding rate to the original coding rate.

When it is intended to change the coding rate as described above, the control part generates a new quadrature code number (Wno) and a new quadrature code length (Wlength) to assign a new channel when the coding rate is changed. This is caused by that when the coding rate is changed, the quadrature code length is also changed. That is, the control part generates the new quadrature code number and length (Wno and Wlength) for generating a quadrature code that is changed according to a selected coding rate and a encoder selection signal (Csel) for selecting the encoder of the coding rate. In this case, when an encoder having a lower coding rate (i.e., ⅙) is selected, the quadrature code is relatively short. When an encoder having a higher coding rate (i.e., ⅓) is selected, the quadrature code is relatively long.

Meanwhile, when the forwarding link uses the first encoder 211 using the ⅓ rate FEC and the second encoder 212 using the ⅙ rate FEC, a path of the data inputted from the transmitter to the first and second encoders 211 and 212 is determined by the selector 201. The data finally outputted from the transmitter are sent via a different rate FEC. That is, the selector outputs thee input data to the first encoder 2111 using the selection signal Csel outputted from the control part when the communication environment is improved, and outputs the same to the second encoder 212 when the communication environment is deteriorated.

In addition, since the use of the quadrature code should be changed by the different rate FEC, one of the first and second quadrature modulators 261 and 262 is selected and used. That is, when the first encoder 211 is selected, since it is a signal using the ⅓ rate FEC, the quadrature code generator of the first quadrature modulator 261 generates a quadrature code having a 256 length determined by the quadrature code number and length (Wno and Wlength). Accordingly, the first quadrature modulator 261 multiplies the signal coded as the ⅓ rate with the quadrature code to generate a first quadrature modulating signal, and the spreader 270 spreads and outputs the first quadrature modulating signal using the PN sequence, PNI and PNQ.

When the second encoder 211 is selected, since it is a signal using the ⅙ rate FEC, the quadrature code generator of the second quadrature modulator 262 generates a quadrature code having a 128 length determined by the quadrature code number and length (Wno and Wlength). Accordingly, the second quadrature modulator 262 multiplies the signal coded as the ⅓ rate with the quadrature code to generate a second quadrature modulating signal, and the spreader 270 spreads and outputs the second quadrature modulating signal using the PN sequence, PNI and PNQ.

As described above, the constitution of the spreader 270 for spreading the signal that is quadrature-modulated using the PN sequence after it is quadrature-modulated. Accordingly, the ⅙ rate REC is identical to the ⅓ rate REC except for the encoder and the interleaver. In case of the ⅙ rate FEC, a bit rate at the final end is increased from 576-bit/frame to 1152-bit/frame. The interleaver size is increased by two times.

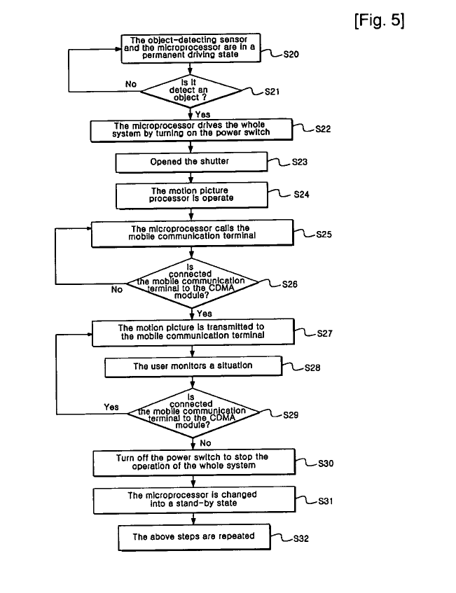

FIG. 4 shows a flowchart illustrating a motion picture transmission process when a mobile communication terminal calls a wireless camera having a CDMA module according to a preferred embodiment of the present invention. The following description is based on an assumption that the wireless camera of the present invention is installed by an individual user.

As shown in the flowchart, a calling-connection to the CDMA module installed in the wireless camera is performed using the mobile communication terminal (S1). When the calling-connection signal is transmitted from the mobile communication terminal to the CDMA module 20, a ringing signal is transmitted to the CDMA module 20 (S2). The ringing signal is then inputted into the microprocessor 30, and the microprocessor 30 turns on the power switch 40 in response to the ringing signal (S3). An identifying process for the use of the wireless camera is performed using a preset password (S4). When the user is not identified, the operation of the system is stopped. When the user is identified, the shutter 10 is opened (S5) and the motion picture processor 1 is operated (S6). The motion picture is transmitted to the mobile communication terminal connected to the CDMA module 20 (S7). The user monitors a situation of the remote place where the wireless camera is installed in real time (S8). When the user wishes to continuously monitor the situation of the remote place, he/she maintains the connecting state between the CDMA module of the wireless camera and the mobile communication terminal, and when he/she doesn't, she disconnect the communication. At this point, when it is checked out by the microprocessor 30 that the connecting state is maintained, the microprocessor continuously transmits the motion picture to the mobile communication terminal, and when it is checked out that the connecting state is cut off, the microprocessor 30 stops the transmission of the motion picture and turn off the power switch 40 to stop the operation of the whole system (S9-S10). Meanwhile, the shutter 10 that has been opened is closed again, and the microprocessor 30 is changed into a stand-by state for detecting the ringing signal. The above steps are repeated in response to the detection of the ringing signal (S11-S12).

The system of the present invention can be installed on a public place such as a preschool. In this case, a plurality of persons can connect with the CDMA module by inputting their passwords.

FIG. 5 shows a flowchart illustrating a motion picture transmission process when a wireless camera with a CDMA module calls a mobile communication terminal according to a preferred embodiment of the present invention.

The system maintains a minimized stand-by state as the object detecting sensor and the microprocessor 30 are in a permanent driving state (S20). When the object-detecting sensor detects an object (S21), the microprocessor 30 drives the whole system by turning on the power switch 40 (S22). As a result, the shutter 10 is opened S23 and the motion picture processor 1 is operated (S24). Meanwhile, the microprocessor 30 calls the mobile communication terminal whose information is stored in the microprocessor 30 (S25). When the mobile communication terminal is connected to the CDMA module 20 (S26), the motion picture is transmitted to the mobile communication terminal of the user (S27) so that the user can monitor the situation of the remote plate (S28). When the user wishes to continuously monitor the situation of the remote place, he/she maintains the connecting state between the CDMA module of the wireless camera and the mobile communication terminal, and when he/she doesn't, she disconnect the communication. At this point, when it is checked out by the microprocessor 30 that the connecting state is maintained, the microprocessor continuously transmits the motion picture to the mobile communication terminal, and when it is checked out that the connecting state is cut off, the microprocessor 30 stops the transmission of the motion picture and turn off the power switch 40 to stop the operation of the whole system (S29-S30). Meanwhile, the shutter 10 that has been opened is closed again, and the microprocessor 30 is changed into a stand-by state for detecting the ringing signal. The above steps are repeated in response to the detection of the ringing signal (S31-S32).

The process illustrated in FIG. 4 shows a method that the user can monitor the situation of the remote place by the user directly connecting at his/her wanting time. The process illustrated in FIG. 5 shows a method that the user can monitor the situation of the remote place only when the object-detecting sensor detects an object.

However, the to methods can be applied as a combination in the system of the present invention.

### INDUSTRIAL APPLICABILITY

As described above, the wireless camera with the CDMA module and the motion picture transmission system using the wireless camera allow a user to identify a situation of a remote location in real time by directly calling the wireless camera using a mobile terminal or by calling the mobile terminal using the CDMA module of the wireless camera.

Therefore, since there is no need of the separate storage device and a repeater, the manufacturing cost can be saved and the size of the system can be reduced, making it easy to install the system in a limited space.

It will be apparent to those skilled in the art that various modifications and variations can be made in the present invention. Thus, it is intended that the present invention covers the modifications and variations of this invention provided they come within the scope of the appended claims and their equivalents.

1. A wireless camera with a CDMA module, comprising:
a motion picture processor for taking an image;
a communication processor comprising a ringing detector for generating a ringing signal by detecting a calling-connection signal to the CDMA module that processes a communication signal for a wireless transmission of the image;
a control part comprising a microprocessor for operating a whole system by detecting the ringing signal and controlling image and sound signals and a memory storing an identification code of a mobile communication terminal and a system operation program including an image processing program; and
a power controller comprising a battery for supplying operation power and a power switch controlled by the microprocessor to switch power supply.

2. The wireless camera of claim 1, wherein the motion picture processor comprises a shutter operated by the microprocessor, an image capturer for capturing an image using a charge coupled device, a sound capturer for capturing a sound, an image signal processor for receiving an image signal from the image capturer, extracting correlated double sampling (CDS) data from the image signal, and performing an auto gain controller (AGC) amplification, an AID converter for converting data of the image signal processor into R, G and B image data through a digital formatting, an image data compressor for compressing the R, G and B image data, a buffer memory 16 for temporarily storing the compressed image data, an address oscillator for supplying a writing address (Wad) used for writing to the buffer memory, and an image transmitter for generating a signal to be transmitted from the mobile communication terminal to the communication processor.

3. The wireless camera of claim 1, wherein the CDMA module comprises:
first and second channel encoders for respectively coding a transmission signal into first and second predetermined coding rates;
first and second interleavers for interleaving corresponding coding data by a frame;
a selector for connecting the transmission signal to the corresponding channel encoder having the corresponding coding rate using a coding rate selecting signal and selecting and outputting output of the corresponding interleaver;
a quadrature modulator for generating a quadrature code corresponding quadrature code information and spreading the coding data outputted from the selected interleaver as the quadrature code; and
a PN spreader for spreading and transmitting the quadrature code.

4. The wireless camera of claim 1, further comprising an object-detecting sensor coupled to the microprocessor.

5. The wireless camera of claim 1, wherein the object-detecting sensor is an infrared sensor.

6. The wireless camera of claim 1, wherein the object-detecting sensor is a microwave sensor module.

7. The wireless camera of claim 6, wherein the microwave sensor module comprises a radio frequency oscillator for generating radio frequency; a radio frequency amplifier for amplifying the radio frequency; a transmitting antenna for transmitting the amplified radio frequency to the air; a receiving antenna for receiving the radio frequency sent from the transmitting antenna, the receiving antenna being integrated with the sensor circuit part; a frequency synthesizing part for synthesizing the signal reflected from an object and the radio frequency;
and a frequency converting part for converting the synthesized frequency into frequency of a medium frequency band.

8. The wireless camera of claim 1, wherein the quadrature code information includes a quadrature code number and a quadrature code length.

9. The wireless camera of claim 1, wherein the motion picture processor comprises a charge couple device.

10. A motion picture transmission system using a wireless camera with a CDMA module, comprising:
a motion picture processor comprises a shutter operated by a microprocessor, an image capturer for capturing an image using a charge coupled device, a sound capturer for capturing a sound, an image signal processor for receiving an image signal from the image capturer, extracting correlated double sampling (CDS) data from the image signal, and performing an auto gain controller (AGC) amplification, an A/D converter for converting data of the image signal processor into R, G and B image data through a digital formatting, an image data compressor for compressing the R, G and B image data, a buffer memory for temporarily storing the compressed image data, an address oscillator for supplying a writing address (Wad) used for writing to the buffer memory, and an image transmitter for generating a signal to be transmitted from the mobile communication terminal to the communication processor;
a communication processor comprising the CDMA module including first and second channel encoders for respectively coding a transmission signal into first and second predetermined coding rates, first and second interleavers for interleaving corresponding coding data by a frame, a selector for connecting the transmission signal to the corresponding channel encoder having the corresponding coding rate using a coding rate selecting signal and selecting and outputting output of the corresponding interleaver, a quadrature modulator for generating a quadrature code corresponding quadrature code information and spreading the coding data outputted from the selected interleaver as the quadrature code, and a PN spreader for spreading and transmitting the quadrature code and a ringing detector for generating a ringing signal by detecting a calling-connecting signal to the CDMA module;
a control part comprising the microprocessor for operating a whole system by detecting the ringing signal and controlling image and sound signals and a memory storing an identification code of a mobile communication terminal and a system operation program including an image processing program;
a power controller comprising a battery for supplying operation power and a power switch controlled by the microprocessor to switch power supply; and
a mobile communication terminal for receiving the motion picture information by call-connecting the wireless camera.
